(19) United States
(12) Patent Application Publication
(10) Pub. No.: US 2002/0197474 A1
(43) Pub. Date: Dec. 26, 2002

(54) Functionalized fullerenes, their method of manufacture and uses thereof

(76) Inventor: Thomas A. Reynolds, Bend, OR (US)

Correspondence Address: The Halvorson Law Firm, Ste 1, 405 W. Southern Ave., Tempe, AZ, 85282, US

(21) Appl. No.: 10/163,022

(22) Filed: Jun. 3, 2002

Related U.S. Application Data
(60) Provisional application No. 60/296,361, filed on Jun. 6, 2001.

(51) Int. Cl. B32B 1/08

(52) U.S. Cl. 428/398; 428/408

(57) ABSTRACT

The present invention provides a novel method for functionalizing the surfaces (and interior) of nanotube like materials using a plasma source. These plasma-functionalized carbon nanotubes (CNTs) are useful for preparing a variety of different composite fibers having improved characteristics, such as conductivity and mechanical strength. The key innovation being pursued is the development of plasma-based methods for plasma-functionalizing the surfaces of CNTs with reactive chemical groups that covalently bind to polymers and prepolymers.

This application is a continuation of pending provisional application serial No. 60/296,361 filed on Jun. 6, 2002.

### FIELD OF THE INVENTION

The present invention relates broadly to nanostructures, such as graphitic nanotubes, which includes tubular fullerenes (commonly called “buckytubes”) and fibrils, which are functionalized by covalently bonding functional moieties onto the surface of the nonotubes. More specifically the invention relates to graphitic nanotubes that are uniformly or non-uniformly functionalized with chemical moieties or upon which certain cyclic compounds are covalently bonded and to complex structures comprised of such functionalized fibrils linked, such as polymerically, to one another and uses thereof. The present invention also relates to methods of introducing functional groups onto the surface of such fibrils.

### BACKGROUND OF THE INVENTION

There is always a demand for ultrahigh performance fibers and fiber-based materials. Fibers that are rugged, lightweight, flexible and can be integrated into fabrics, are considered optimal. It is especially desirable to develop fabrics that include multifunctional characteristics, such as by combining strength, barrier and/or electronic capabilities into the fibers. Examples of barrier system capabilities may include, but are not limited to, protection against electromagnetic, thermal, and/or chemical/biological effects, or the like. Examples of electronic capabilities include, but are not limited to, electrical conductivity, photoconductivity or the like.

It is obvious that any electronic systems formed using fiber-based materials will require system integration using small wires and interconnects, and will likely demand wearable power storage sources such as batteries and ultra-capacitors. Generation/scavenging of this power, such as by using solar cells and piezoelectric materials, even at moderate efficiencies, could significantly enhance system performance and practical use duration. An ideal component candidate for integration into this task is lightweight Carbon Nanotube (CNT) composite fibers.

CNTs are nanoscopic-scale moieties having a number of favorable properties including: one-half the density of aluminum, one fifth the density of copper, tensile strengths 100 times that of steel, thermal conductivity equivalent to diamond, resistant to attack by chemicals, and tunable electrical properties ranging from copper-like conductivity to semiconductivity.

In order to take full advantage of CNT technology on a practical scale, and integrate the favorable properties of CNTs into composite fibers, several problems need to be overcome. For example, these problems include adhesion to of the polymeric phases to the CNTs, reducing the minimal separation between CNTs and the polymer phases, and perhaps directed orientation of CNTs within the fiber.

Recent studies reported in the literature describe the preparation and application of simple carbon nanotube/polymer composites. These composites have been prepared by the addition of untreated CNTs to a variety of synthetic fiber precursors, such as thermoset epoxies, polyphenylacetylenes, polyparaphenylenevinylenes, nylon-6, polyhydroxyaminoether, polyvinylalcohol, polystyrene, and PMMA.

A main issue in the development of composite materials for electronic and structural applications is to select a polymeric material that adheres well enough to the nanotube surface to provide sufficient mechanical properties, yet maintaining an interconnected physical pathway. Several strategies can be implemented to promote adherence between the polymer and nanotube, including the following: 1) π-π interactions, 2) hydrophobic interactions, and 3) covalent attachment. Due to the graphitic π-electron-rich surface of single walled nanotubes (SWNT's), it is likely that they will form strong π-π interactions with polymeric materials that contain aromatic groups, as evidenced by the use of resins that contain Bis-Phenol A, and the phenylacetylenes. Also, the hydrophobicity of SWNT's favors adherence to hydrocarbons in general. However, this type of adhesion will ultimately be the limiting factor in the strength of the composite. The most desirable method for forming a strong nanotube/polymer composite is to covalently bond the CNT to the polymer, which requires functionalization of the CNT surface with a reactive chemical group.

There are techniques for chemically modifying the ends and surfaces of CNTs with functional groups that bind to polymers and metal ions. One method involves reacting the nanotubes with oxidizing chemicals (acids or peroxides) at relatively low temperatures (<200° C.). This results in the formation of reactive oxide groups such as carboxylic acids and hydroxides that are adsorbed on the surface of the CNTs. These groups can be used to bind specific polymers or prepolymers or can be further modified to incorporate groups such as epoxides, reactive acid chlorides, or amines. Once the surface is modified, it can be contacted with a polymer solution possessing a pendant functional group that can then bound to the functionalized nanotube. This has been demonstrated by attaching poly(ethyleneimine) to acid-chloride-functionalized multiwalled nanotubes (MWNTs) through amide linkages.

The acid- and amine-functionalized CNTs have been used to further bind siloxane to the surface of the CNTs (the reactivity of the chlorosilane with the functionalized CNTs is significantly greater than was the reaction with non-functionalized CNTs). In this procedure, chlorosilane derivatives are reacted with functionalized CNTs to form a variety of siloxane-functionalized nanotubes.

However these wet chemistry functionalization schemes are expensive in time and materials because the CNTs must be immersed in solution for at least 0.5 hours (or up to several hours) for sufficient amounts of functional groups to adhere to the CNT surfaces. Moreover, the strength of the adsorption linkage is not as strong as a covalently bonded linkage would be.

Thus, it can be seen there is a present and continuing need for new and improved functionalized CNTs and methods for the manufacture thereof. The improved functionalized CNTs may be used in multifunctional, ultra-high-performance fibers. Successful production of multifunctional, ultra-high-performance fibers containing carbon nanotubes will pave the way for significant improvements in existing-fiber based applications and allowing for new technologies to be tested and implemented.

### SUMMARY OF THE INVENTION

It is an object of the present invention to provide a new plasma-based technique to produce plasma-functionalized CNTs that have reactive chemical groups covalently bound to their surfaces

It is another object of the present invention to covalently bind the plasma-functionalized CNTs to polymer phases.

It is another object of the present invention to provide a variety of composite fibers by mixing plasma-functionalized carbon nanotubes with polymeric precursors and reacting to form high-performance composite polymers, such as CNT-polyimide composites.

It is yet another object of the present invention to manufacture continuous composite fibers made from these composites.

It is a further object of the present invention to heat-treat the new composite fibers at various temperatures to form a range of carbonized composite fibers with varying degrees of carbonization, wherein various properties of the carbonized fibers are strongly dependent on the heat-treatment regime.

It is yet a further object of the present invention to provide new composite fibers with improved electrical, mechanical, morphological properties compared with those of fibers that do not incorporate plasma-functionalized nanotubes.

It is still yet a further object of the present invention to provide new composite fibers containing functionalized CNTs that are photoconductive, showing significant changes in electrical conductivity upon exposure to low-power laser light, wherein the photoconductive property of the new fibers allow them to function as electromagnetic (EM) sensors

It is a further object of the present invention to provide new composite fibers containing functionalized CNTs having superior mechanical properties when compared with the fibers that contained non-functionalized CNTs (e.g., a 4-fold increase in tensile strength, 33% increase in elastic modulus).

The novel features that are considered characteristic of the invention are set forth with particularity in the appended claims. The invention itself, however, both as to its structure and its operation together with the additional objects and advantages thereof, will best be understood from the following description of the preferred embodiment of the present invention when read in conjunction with the accompanying drawing. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1. Infrared Spectrum of CNTs after Plasma Treatment in an Ar/O₂ Atmosphere for 15 minutes. Results indicate formation of oxygen bearing groups on CNTs.

FIG. 2. Surface area of CNTs as a function of treatment. Test Conditions: Micromeritics 2000 BET Surface Area Analyzer, N₂/He gas, 77K; each data point is an average of at least 3 measurements; plasma conditions, 13.56 MHz, 100W, 30 mTorr.

FIG. 3. Viscosity of Polyimide Precursor Solutions.

FIG. 4. Electrical Resistivity at 23° C. of Fibers Heat-treated to a Maximum Temperature of 900° C. 15 minutes under Ar gas.

FIG. 5. Tensile Strength of Fibers. P-CNTs indicate CNTs that were functionalized in an Ar/O₂ Plasma for 15 minutes prior to addition to the polyimide solution. Fibers imidized to a final temperature of 375° C. for on a 12 hour heat profile.

FIG. 6. Polyimide Fiber Containing 1.7 wt % Plasma-Treated CNTs (scale in mm).

FIG. 7. Elastic Modulus of Polyimide-Based Fibers. P-CNTs indicate CNTs that were functionalized in an Ar/O₂ Plasma for 15 minutes prior to addition to the polyimide solution. Fibers imidized to a final temperature of 375° C. on a 12 hour heat profile.

FIG. 8. Cross-sections of imidized fibers containing a) 30% wt (solution) polyimide polymer; b) 30% wt polyimide polymer plus 0.5% wt CNTs; and c) 30% wt polyimide polymer plus 0.5% wt plasma-functionalized CNTs. Note that the each of the fibers contains a significant concentration of voids.

FIG. 9. Tangential cross sections of the same fibers better illustrate the difference in void distribution between the three formulations. Note also the dense skin on the surface of each fiber, likely due to rapid solvent exchange taking place as the fibers are immersed into the solvent-exchange bath.

FIG. 10. Details of cross sections from center domains of fibers, all at 5910× magnification. The difference in pore size and structure in b) is most likely due to the effect of non-covalently bound SWNT's. The similarity in pore sizes of a) and c) is evidence that the functionalized SWNT's are bound covalently to the polymer, allowing c) to assume a structure more like the polymer control, but with enhanced physical properties.

FIG. 11. SEM photos detail cross-section from an imidized fiber containing 1.7 wr % non-functionalized CNTs; a) magnification 10K×, b) details at magnification 20K×).

FIG. 12. Details of imidized fiber containing 1.7 wt % functionalized CNTs. Numerous regions of this sample contained ropes of CNTs spanning voids, and possibly under tension.

FIG. 13. Generic Reaction to Produce Polyimide-Linked CNT Polymers.

### DETAILED DESCRIPTION OF THE PREFERRED EMBODIMENTS

The present invention provides a novel method for functionalizing the surfaces (and interior) of nanotube like materials using a plasma source. These plasma-functionalized carbon nanotubes (CNTs) are useful for preparing a variety of different composite fibers having improved characteristics, such as conductivity and mechanical strength. The key innovation being pursued is the development of plasma-based methods for plasma-functionalizing the surfaces of CNTs with reactive chemical groups that covalently bind to polymers and prepolymers.

Another advantage of using plasma-functionalized CNTs is that the CNTs have a reduced tendency to agglomerate due to stearic factors and are well dispersed in the polymer matrix, as indicated by SEM analysis. The composition of these novel composite fibers can be tailored to optimize the following properties: strong adhesion between the CNTs and the polymer phase, minimal agglomeration of the CNTs, low mass density, electrical- and photo-conductivity, mechanical strength and flexibility, and temperature stability ranges (broad).

The plasma-induced functionalization of the CNT surfaces produces a covalent bond between the surface and the functional group. As discussed above, the functional group may then be covalently bonded to prepolymer precursors. The covalent bonding between the plasma-functionalized CNTs and the prepolymer phases eliminates phase-separation problems experienced by other functionalization methods, thereby significantly improving a variety of physical properties of the CNT composites. An example set of high-performance composite polymers have been prepared, as discussed below, using polyimides, which have been selected based on their widespread applications in areas such as high-strength composites, electronics, thermal and chemical barriers, and sensors.

Once fabricated, the plasma-functionalized CNT composites were evaluated in terms of electrical and mechanical properties as a function of chemical functionality on the CNTs, polymer type, the CNT/polymer ratio, and a number of other key parameters. This evaluation clearly demonstrates that plasma-functionalized CNT/polymer composites have superior physically properties relative to composites using CNTs functionalized by other methods or composites that do not contain functionalized nanotubes.

Plasma-Induced Functionalization Methods

Plasma-induced techniques to covalently attach specific functional groups to CNT surfaces have been found to be superior to other functionalization methods. This technique is a rapid and effective method for functionalizing carbon nanotubes that is readily scaled for commercial production. Plasma-induced functionalization may be used to attach a wide variety of different chemical moieties including, but not limited to, oxygentated CNTs containing carboxylate, hydroxyl, aldehyde, and ketone moities using an argon/oxygen plasma; and aminated CNTs containing using an ammonia plasma.

In plasma-functionalizing the surfaces of the CNTs, different plasma frequencies, power levels, and chamber configurations were evaluated. Key variables in plasma-functionalization of CNTs include the following: plasma frequency (kHz to MHz), power level (20-3000 W), type of gas, graft polymerization of polymer directly on CNT surface, and duration of treatment.

The basic procedure for plasma-induced functionalization involves supporting the CNTs on a ceramic sample-holder inside a plasma chamber (typically a quartz tube). The plasma chamber is equipped with inlet and outlet ports for the introduction and removal of gases. Both inlet and outlet ports are connected to a gas chromatograph (GC) to monitor the types and concentrations of gas in the chamber, and also potential by-products formed. Additional gases or reactants can be introduced into the chamber via additional inlet ports. Alternatively, solids or liquids can be converted into gas-phase reactants by placing them in a crucible in the oven and heating to vaporization.

In a typical run, the plasma chamber is evacuated to remove unwanted gases and is back-filled with an appropriate gas. This procedure is cycled several times and monitored with a gas chromatograph (GC). Next, a plasma is struck by applying a known voltage to electrodes at a given frequency and current. The frequency and power level is maintained and monitored by a control unit. The electrical current can also be adjusted with the gas flow. The GC is also used to aid in determining optimum reaction times by monitoring the concentration of reactants entering and exiting the chamber.

Plasma-induced functionalization covalently links monomers or reactive polymers directly onto the CNT surface. An example of this process would be the graft-polymerization of a polyimide precursor, oxydianiline (ODA) onto nanotube ends. This, in turn, sets the foundation for further reactions, including graft-polymerization of BDTA onto the ODA.

Samples of plasma-functionalized CNTs were evaluated using a variety of techniques, including: solvent wetting, infra-red (IR) absorption spectroscopy, and surface area analysis.

Infrared Spectroscopy

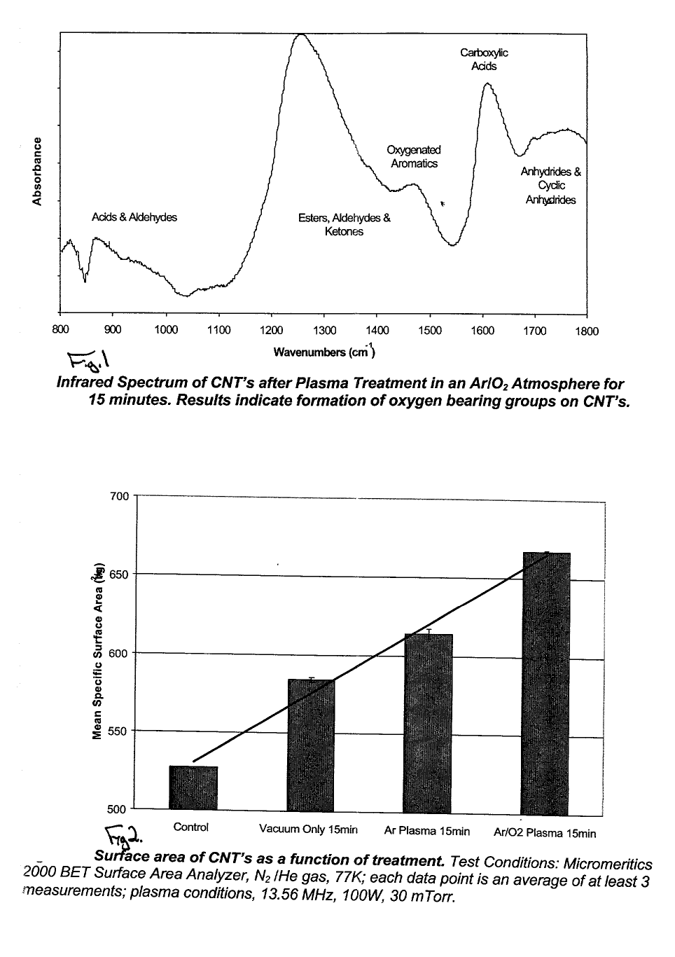

Infrared Spectroscopy was used to identify the different types of functional groups plasma treatment induced on the CNT surfaces. For these measurements, plasma-treated CNT samples were sandwiched between two ZnSe prisms in an ATR configuration and placed in the beam path of a Fourier Transform Infrared (FTIR) spectrophotometer operating in a single-beam mode. FIG. 1 shows a spectrum of a CNT sample treated in an Argon/Oxygen (Ar/O₂) plasma. To enhance the spectral characteristics, a spectra of non-modified CNTs was used as a baseline and subtracted from the spectra. The spectra clearly show the presence of a wide range oxygenated species and further demonstrates that the plasma treatment modifies the CNT surfaces.

Solvent Wetting

To rapidly determine the qualitative effects of plasma-functionalization, a series of liquid contact measurements was performed. This was accomplished by placing a small drop of different solvents (e.g., 25 μl) onto disks of plasma-functionalized and untreated (control) CNTs, and observing the ability of each different solvent to wet the surfaces. This information was also used to select preferred co-solvents for forming CNT/polymer composites. It was determined that plasma-functionalized CNTs showed markedly improved wetting characteristics when compared with the non-functionalized CNT control. For all solvents, including water, the plasma-functionalized CNTs were readily wetted. Qualitative results are shown in Table 1.

TABLE 1
Surface Wetting of CNTs by Solvents.

| Solvent | Plasma-Functionalized CNT | CNT Control |
|---|---|---|
| Water (DI) | readily wetted | non-wettable |
| Ethanol | readily wetted by all solvents | non-wettable |
| Methanol | | wettable, |
| Isopropanol | | non-wettable |
| Acetone | readily wetted by all solvents | non-wettable |
| Dimethyl | | wettable, |
| Formamide | | non-wettable |
| Tetrahydrofuran | | |
| Benzene | readily wetted by all solvents | Tom what |
| Toluene | | happened here? |
| Nitric Acid | readily wetted by all solvents | dissolved |
| Sulfuric Acid | | readily wetted |
| Acetic Acid | | slightly wetted |
| Phosphoric Acid | | readily wetted |
| Sodium Hydroxides | | slightly wetted |

The above qualitative results indicate that the plasma-functionalization method produced plasma-functionalized CNTs that are easily dispersed in a variety of solvents, whereas the non-treated CNTs were for the mostpart not wettable with numerous solvents tested, thereby making them difficult to uniformly disperse in the solvents.

Surface Area

The effect of plasma-functionalization was further characterized by evaluating the surface area using BET methods and N₂ at 77° K as the absorbent gas. The objective of this measurement was to determine how the plasma treatment affected the surface area of the CNTs. Results are plotted in FIG. 2. Tests were performed using purified CNTs. Samples were weighed in glass sample tubes and degassed in a flow of N₂/He (70:30) at 200° C. Samples were run through multiple sorption and desorption cycles until the measured surface area became consistent.

FIG. 2 shows the surface area of the CNTs and shows a near linear increase in surface area with treatment, maximizing with a plasma treatment of Ar/oxygen for 15 minutes. These measurements clearly indicate that the plasma treatment increases the surface area of the CNTs.

The plasma functionalization of CNTs represents a significant tool for CNT modification that is readily scaleable for commercial-scale batches. It is also possible to functionalize CNTs with a multitude (more than one) of different reactant groups.

Composite Formation

Composite formulations based on polymers and CNTs are demonstrated in preparation for fiber spinning. A wide variety of polymers were screened, including polyimide, polyvinylidene fluoride, polypropylene, polyvinyl alcohol, polyacrylonitrile, and polysiloxanes. Screening of these polymers included mixing the polymers with CNTs, formation of thin films, and evaluation of CNT dispersion using an optical microscope. Based on these studies, it was determined that both functionalized and non-functionalized CNTs were uniformly dispersed in polyimides and polyimide precursors.

Polyimides are a large and diversified class of high-performance polymers whose properties can be tailored to meet the demands of a wide range of functions. They demonstrate excellent mechanical properties, are thermally stable at temperatures up to 400° C., and are resistant to attack in harsh chemical and electromagnetic environments. Polyimides are typically formed by reaction of two different monomers, a cyclic dianhydride, and diamine. Typical starting materials for this reaction can be tetracarboxylic dianhydride and meta-phenylene diamine. When combined and mildly heated, these chemicals form a polyamic acid. When further heated to about 300° C., an imidization reaction occurs, resulting in a high-peformance polyimide polymers. Further, polyimides can be prepared with a variety of different functional groups, hence allowing a range of options for interaction with functionalized CNTs.

For liquid samples, dispersion of the functionalized CNTs into the appropriate prepolymer phases will be accomplished using a combination of sonication and vacuum mixing methods. This results in reducing aggregation of nanotubes and minimizing bubble formation. The key variables to be controlled are the type of functionalized CNT/pre-polymer combination, the CNT/prepolymer, solvent and viscosity of starting mixture, duration of and frequency and power of sonication, duration of mixing, and temperature and pressure. The formulations will be evaluated for viscosity, bubble formation, and phase separation using an optical microscope.

Polyimides can be fabricated into fibers via wet or melt fiber spinning methods. In wet-spinning, a major consideration is effective solvent exchange in a quench bath-a critical aspect of polymer formation that is largely regulated by the bath conditions. Variables include quench bath formulation, flow dynamics, temperature, residence time in the bath, and the tension maintained on the fiber (via a tensiometer) during the quenching process. This initial quenching forms a skin on the fiber, but may not be sufficient to rinse solvent from the interior of the fiber, in which case an additional rinse bath may be necessary. Variables for such a rinse bath would be those listed above, and would be similarly tailored to ensure complete solvent exchange. Finally, fibers must be effectively dried of all water before any heat treatment may occur-an operation requiring fiber-heating or air-drying methods.

Methods are demonstrated for spinning solid fibers of the polyamic acid/CNT mixtures and for imidizing the fiber forming and polyimide (PI) fiber containing CNTs. The initial work was performed using small-scale spinnerets and the above-described solutions. Two different spinning methods were tried. The first involved extruding the polymer into a quench bath containing DI water and SDS surfactant, followed by rinsing the fiber in DI water and heating to 300° C. in air. This method resulted in an opaque fiber with a somewhat porous skin and interior. The second method involved extrusion of the fiber directly into a hot stream of air (200-300° C.). This resulted in a fiber that was semi-translucent and relatively free of voids; however, these fibers were subject to thinning and necking, causing difficulty in interpretation of test results. Hence, the preferred method for the fiber-fabrication efforts is the solution-spinning method.

Reactant solutions were prepared for wet fiber-spinning. Polyamic acid (i.e., polyimide precursor) solutions for fibers were synthesized by dissolving a 1:1 mole ratio of 4,4′-oxydianiline (ODA) and 3,3′,4,4′-Benzophenonetetracarboxylic dianhydride (BTDA) in N,N-Dimethyl formamide (DMF). Preliminary studies of solution concentrations led to the use of 30% wt solids, to which different concentrations of CNTs were added.

To achieve the best uniform dispersion of nanotubes and complete mixing of polymer precursors, the CNTs were added to solutions after the ODA and before the BTDA. The solutions were allowed to mix to disperse the CNTs and to allow, in the case of plasma-treated CNTs, covalent bonding between monomer and functional groups on the CNTs. Finally BTDA was added, resulting in a significant increase in viscosity. Mechanical mixing under closed vacuum was done for approximately 30 minutes, until solutions were no longer exothermic.

A typical procedure for preparation of polyimide-based fibers is as follows: the polyamic acid/CNT composite will be dissolved in a suitable solvent (e.g., N-methylpyrrolidone or dimethylacetamide) at a concentration of 5 to 20 wt %, depending on solution viscosity. The polymer solution will be extruded through the spinneret head (100-μm-diameter holes) directly into a quench bath consisting of water or a water/alcohol solution. After the fibers are rinsed for about 5 minutes, they are further rinsed for 15 minutes in flowing DI water, followed by rinsing in an isopropyl alcohol bath for 30 minutes and air-dried. The polyamic acid will then be heated to 300° C. under a flow of nitrogen gas for a period of two hours, forming the polyimide/CNT fiber. Fibers may then be further carbonized under a flow of nitrogen gas. Heating profile (20° C. up to 500° C., 20° C./hr, held at 500° C. for 10-60 min).

While extruded fibers are solidifying, or in some cases even after they have hardened, the filaments may be drawn out (i.e., stretched) to impart added strength by orienting the contained CNTs along the fiber direction. Drawing the fibers out pulls the molecular chains together and orients them along the fiber axis, creating a considerably stronger fiber. A recent study demonstrating the spinning of carbon nanotubes into fibers used a laminar flow in the quench bath to orient nanotubes axially in the fibers.

Viscosity Measurements

Test Conditions: Brookfield Viscosometer, T=23.1° C., spindle speed 20 rpm. These results clearly demonstrate a significant increase in viscosity upon addition of non-treated CNTs and plasma-treated CNTs to the polyimide precursor solution. The functionalized CNTs increased the viscosity of the polymer solution by nearly 17 times, and was 4 times greater than that for the solution containing non-functionalized tubes. This is a significant result, as it indicates a strong bonding interaction between the functionalized tubes and the polymer. While both CNT containing solutions were much thicker than the polymer alone, the plasma-functionalized CNT containing solution was significantly more viscous, having the consistency of spackle.

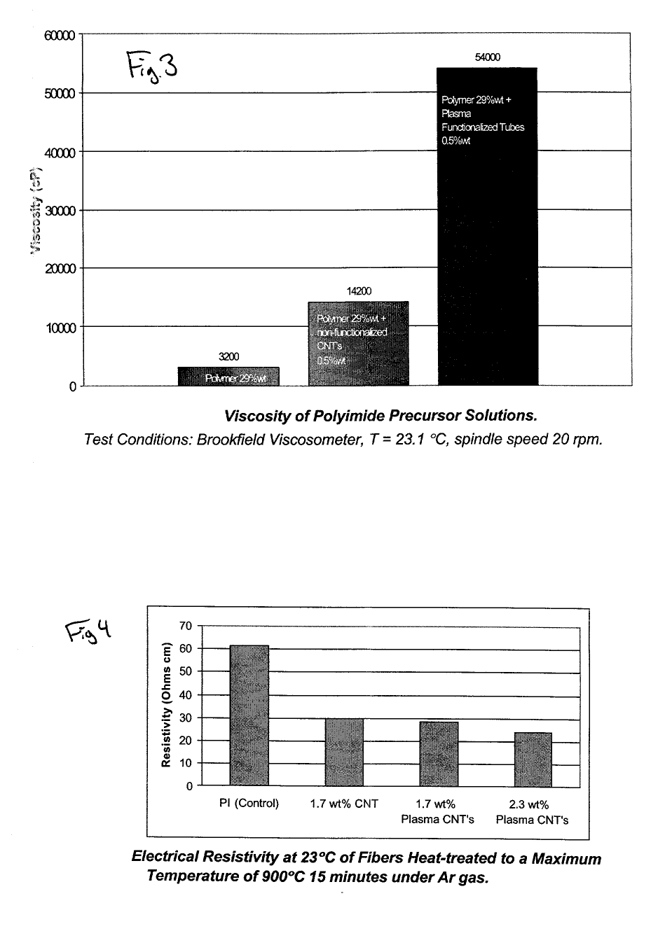

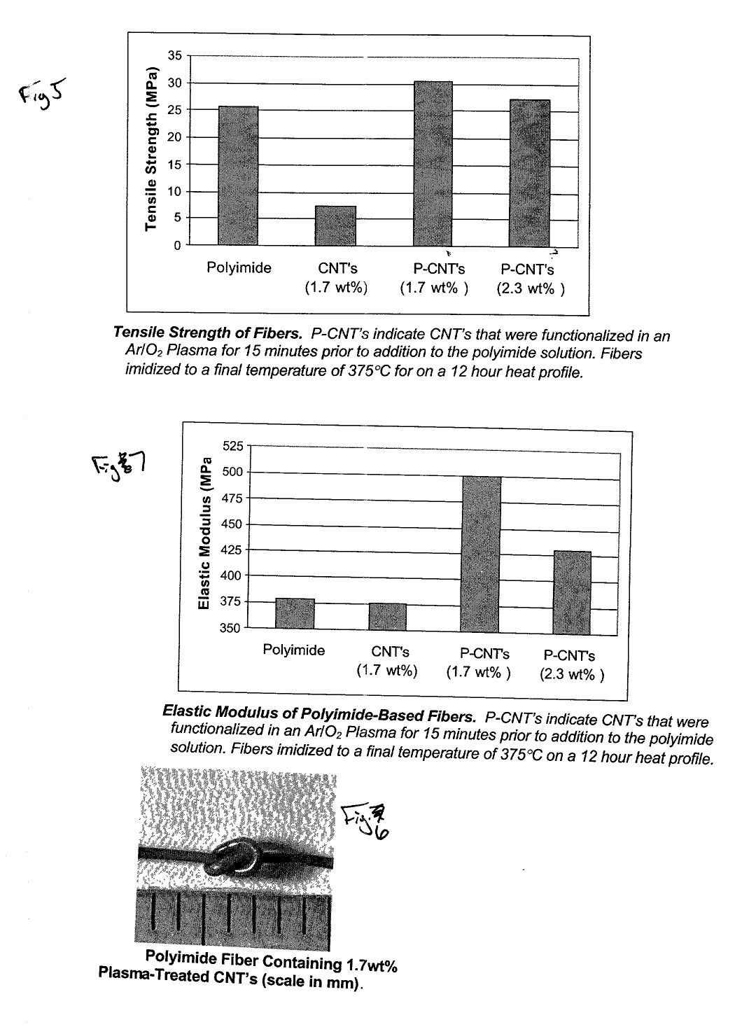

The change in viscosity of the above solutions upon addition of both untreated and plasma-treated CNTs provides an indication that strong chemical bonding is occurring between the CNTs and the polyimide precursor. To quantify this, the viscosities of the separate solutions were determined. Results are shown in FIG. 3. As can be seen, the results of this study indicate that the functionalized CNTs result in an increase in solution viscosity when compared with the sample that contains non-functionalized CNTs or the control.

Carbonization of the Fibers

The fibers were carbonized in the temperature range from 500° C. to 1000° C. in a He atmosphere. The objective was to determine if the polyimide/CNT fibers demonstrated an increase in physical properties upon carbonization through promotion of chemical binding with the CNTs. A wide range of fiber samples was produced and carbonized under varying conditions in an effort to identify an optimum set of carbonizing conditions. During the carbonization process, significant weight loss and fiber shrinkage was observed, and the fibers became more brittle as defects and voids became more pronounced, but were still easily handled.

Electrical, Mechanical, and Morphological Properties

Polyimide (PI) fibers containing carbon nanotubes demonstrate significantly improved properties as is demonstrated by evaluation of key physical properties of the fibers.

Electrical Properties

The electrical properties of the PI/CNTs was evaluated as a function of CNT concentration, type, and heat-treatment temperature. Resistivity measurements were conducted using the standard 4-probe technique.

Fibers containing 1.7 wt % CNTs had resistivity a factor on 2.5 times less than the control fiber. The use of plasma-treated CNTs decreased the resistivity by 3%. The resistivity was linearly decreased by 21% by increasing the concentration of CNTs to 21 wt % CNTs.

The resistivity of the fibers heated to temperatures below 700° C. was high, exceeding 50 Kohms. Fibers that were heat-treated to 900° C. had significantly reduced resistance. FIG. 7 shows the resistance measurement results. It can be seen that the electrical resistivity of the fibers increased with increasing temperature, indicating semiconductive-type conductivity.

Photoconductivity

Polyimide-based fibers containing CNTs were tested for photoconductivity using a helium neon laser (CW, 632 nm, 1 mW), and a doubled Nd-YAG laser (CW, 532 nm, 30 mW). Each fiber was formed into a wheatstone bridge configuration by forming a continuous fiber loop 22 mm in diameter and connected to a power supply and voltmeter. The leads for each instrument are opposite and staggered (viz. voltmeter leads at 12 and 6 o'clock, power supply leads at 3 o'clock and 9 o'clock). The circuit was placed in a box containing a flow of He gas at 19° C. Laser light was directed upon the fiber in one quadrant of the wheatstone bridge. Changes in voltage were then tracked in response to the incident laser light.

TABLE 2
Voltage Response of Polyimide/CNT Fibers Upon
Exposure to Laser Light.

| | Voltage Change at | Voltage Change at |
|---|---|---|
| Fiber | 632 nm (1 mW) | 532 nm (30 mW) |
| 2.3% Plasma CNT | 0.08 | 0.34 |
| 2.3% CNT | 0.1 | 0.31 |
| 1.7% Plasma CNT | 0.12 | 0.32 |
| 1.7% CNT | 0.07 | 0.33 |
| Control, no CNT | 0.0 | 0.0 |

Test Conditions: Fibers heat-treated to a temperature of 375° C. on a 12 hours heat profile; 10 second exposure time, average of 3 samples.

As the above data show, the fibers containing both types of CNTs demonstrate a photoresponse to both red and green laser light. The plasma-functionalized CNT containing fibers showed superior voltage changes when 532 nm radiation was directed onto the fiber containing 2.3% plasma-functionalized CNTs and when 632 nm radiation was directed onto the fiber containing 1.7% plasma-functionalized CNTs. The control fibers, which contained no CNTs, showed no voltage changes at when either wavelength was used. This is a significant result and provides and indication that CNT containing fibers, especially plasma-functionalized CNT containing fibers, can be used as light sensors.

Mechanical Properties

The objective in this work was to determine the mechanical properties of the fibers to establish whether the addition of CNTs and functionalized CNTs to the pre-fiber polymer would enhance or degrade the strength. While the full potential of mechanical strength of the fibers has not been assessed, the present data represents general trends associated nanotube addition. Samples consisted of pure polyimide fibers and polyimide fibers containing non-functionalized CNTs and plasma-functionalized CNTs (pf-CNTs). The ultimate mechanical properties of select fibers were measured in tension using a Com-Ten Tensile Tester.

These data show that fibers fabricated from non-functionalized CNTs decreased the fiber strength nearly four-fold when compared with a pure polyimide fiber. Fabrication of fibers that contain the plasma-functionalized CNTs resulted in an increase of tensile strength by nearly a factor of five, compared with the fibers containing CNTs, and a 20% increase in tensile strength when compared with the pure polyimide fiber.

The fiber containing 1.7 wt % of P-CNTs was capable of being tied into a knot. The other fibers tested were not capable of being tied into a tight knot. As shown in FIG. 7, fibers containing the plasma-treated CNTs at 1.7 wt % exhibit more than a 30% increase in the elastic modulus compared with the fiber that contains non-functionalized CNTs or no CNTs. Increasing the pf-CNT concentration by 0.5 wt % to 2.3 wt % results in a decrease of elasticity by 16 percent.

Morphological Studies

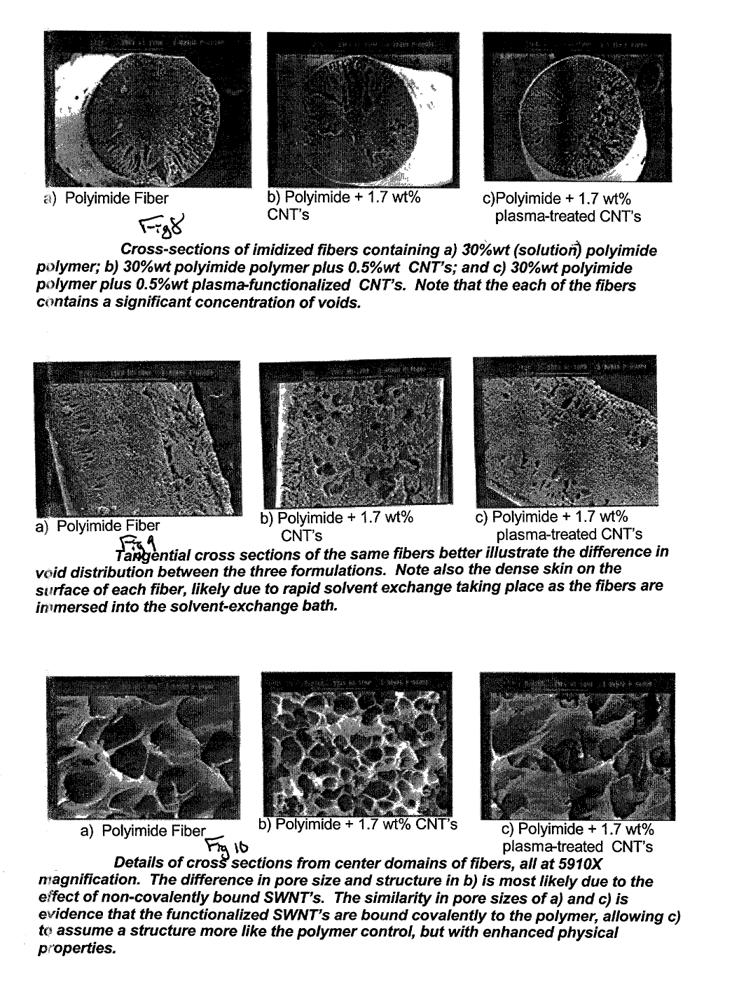

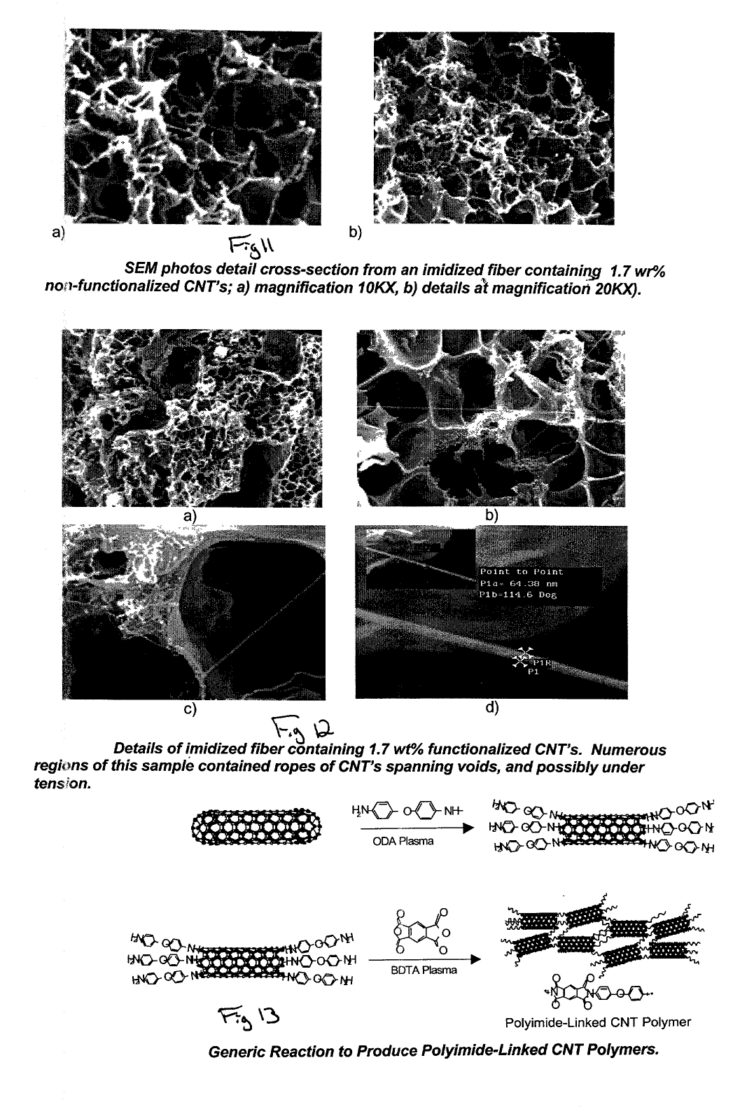

The objective in this work was to characterize the macro- to nano-morphology of the fibers using scanning electron microscopy (SEM). Samples were freeze-fractured at 77° K. Results are shown in FIGS. 8-13.

The preferred embodiment of the invention is described above in the Drawing and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1) A functionalized nanostructure produced by the process of
a) providing a non-functionalized nanostrucutre;
b) applying a plasma of a known plasma gas and of known voltage to a surface of the non-functionalized nanostructure; and
c) applying a functional group to the plasma treated surface of the non-functionalized nanostructure to create a functionalized surface on the nanostructure,
where the functionalized nanostructures has improved electrical and mechanical properties compared to non-functionalized nanostructures.
